(19) United States
(12) Patent Application Publication
(10) Pub. No.: US 2009/0300153 A1
(43) Pub. Date: Dec. 3, 2009

(54) Method, System and Apparatus for Identifying User Datagram Protocol Packets Using Deep Packet Inspection

(75) Inventors: Amar Nath Ray, Shawnee, KS (US); John M. Heinz, Olathe, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/128,763

(22) Filed: May 29, 2008

(51) Int. Cl. G06F 15/173

(52) U.S. Cl. 709/223

(57) ABSTRACT

An embodiment of a method, system and apparatus for prioritizing network datagram traffic includes receiving a datagram packet from a sender device. The datagram packet is addressed to a receiver device and includes a real-time data payload. The method further includes identifying the datagram packet in a network layer using deep packet inspection to determine at least one of an application or protocol associated with the datagram packet. The method still further includes generating traffic priority information associated with the datagram packet based upon identifying the datagram packet. The traffic priority information indicates traffic prioritization between the sender device and the receiver device. Various embodiments further include controlling the sending of the datagram packet to the receiver device based upon the traffic priority information. Some embodiments further include prioritizing traffic between the sender device and the receiver device in accordance with the traffic priority information.

### BACKGROUND

Deep packet inspection (DPI) is a form of computer network packet filtering that examines a data part of a passing-through data packet to search for non-protocol compliance of predefined criteria to decide if the packet can pass through a network. Deep packet inspection is in contrast to shallow packet inspection, generally known as packet inspection that just checks the header portion of a packet. DPI devices have the ability to look at packets in Layer 2 through Layer 7 of the Open Systems Interconnection (OSI) model that include headers and data protocol structures.

DPI allows service providers to readily know the packets of information that are being received on a communications network, such as the Internet associated with e-mail, websites, music sharing, video, and software downloads in the same or similar manner as a network analysis tool. Up to this point-in-time, DPI has been used for security purposes so that a service provider can identify applications that are using network resources and take action if an undesired application is present.

### BRIEF SUMMARY

An embodiment of a method for prioritizing network datagram traffic includes receiving a datagram packet from a sender device. The datagram packet is addressed to a receiver device and includes a real-time data payload. The method further includes identifying the datagram packet in a network layer using deep packet inspection to determine at least one of an application or protocol associated with the datagram packet. The method still further includes generating traffic priority information associated with the datagram packet based upon identifying the datagram packet. The traffic priority information indicates traffic prioritization between the sender device and the receiver device. Various embodiments further include controlling the sending of the datagram packet to the receiver device based upon the traffic priority information. Some embodiments further include prioritizing traffic between the sender device and the receiver device in accordance with the traffic priority information.

An embodiment of an apparatus for prioritizing network datagram traffic includes at least one processor configured to receive a datagram packet from a sender device. The datagram packet is addressed to a receiver device and includes a real-time data payload. The at least one processor is further operable to identify the datagram packet in a network layer using deep packet inspection to determine at least one of an application or protocol associated with the datagram packet. The at least one processor is further operable to generate traffic priority information associated with the datagram packet based upon identifying the datagram packet. The traffic priority information indicates traffic prioritization between the sender device and the receiver device. In various embodiments, the at least one processor is further operable to control the sending of the datagram packet to the receiver device based upon the traffic priority information. In some embodiments the at least one processor is further operable to prioritize traffic between the sender device and the receiver device in accordance with the traffic priority information.

### BRIEF DESCRIPTION OF THE DRAWINGS

Illustrative embodiments of the present invention are described in detail below with reference to the attached drawing figures, which are incorporated by reference herein and wherein:

FIG. 1 illustrates an embodiment of a system for prioritizing network datagram traffic using deep packet inspection (DPI);

FIG. 2 illustrates an embodiment of a DPI module;

FIG. 3 illustrates an embodiment of a user datagram protocol (UDP) packet; and

FIG. 4 illustrates an embodiment of a procedure for prioritizing network datagram traffic using deep packet inspection (DPI).

### DETAILED DESCRIPTION

Packet communication in the transport layer (Layer 4 of the OSI model) based on Transmission Control Protocol (TCP) requires sending an acknowledgement message from the receiver to the sender within a certain period of time after sending a packet to insure to the sender that the packet was received by the receiver. Using TCP produces a robust communication process that minimizes errors in communication. However, because of the delay introduced by using TCP, the use of TCP is not suitable for the delivery of many real-time communications such as voice packets or video packets. When real-time data is to be communicated, datagram packets are typically used in the transport layer. A datagram packet is an independent, self-contained packet sent over a network whose arrival time and valid content are not guaranteed. The use of datagram packets reduces delay by not requiring confirmation between the sender and receiver that the datagram packets have been correctly received. Datagram packets may arrive out of order, appear duplicated, or go missing without notice. Avoiding the overhead of checking whether every packet actually arrives makes datagram packets faster and more efficient for applications that do not need guaranteed delivery. Time-sensitive applications often use datagram packets because dropped packets are preferable to delayed packets. An example of a datagram packet according to one embodiment is a user datagram protocol (UDP) packet.

Because many network applications exhibit similar behaviors, it is difficult for a service provider to correctly identify a particular network application and accurately prioritize network traffic in accordance with the identification using existing identification techniques. Control and prioritization of datagram traffic in a network is made more difficult because the datagram packet protocol does not require the sending of acknowledgment packets between the sender and the receiver. Embodiments of the invention provide for a system and method for accurately identifying datagram packets in a network by using deep packet inspection (DPI) to generate deep packet inspection (DPI) information, and using the DPI information to prioritize network traffic. Embodiments of the invention provide for identifying specific network applications and/or protocols associated with a received datagram packet at a network layer using deep packet inspection to generate DPI information.

The DPI information includes traffic priority information associated with the datagram packet. One or more of the sender, the receiver, and the intermediate network node may then prioritize and/or control traffic flowing from the sender device to the receiver device according to the DPI information. Various embodiments allow service providers to prioritize traffic on their networks according to a particular network application and/or protocol in use. For example, a service provider may wish to lower the priority of datagram traffic associated with peer-to-peer file sharing applications. Embodiments of the invention provide for prioritization of network traffic without requiring any assistance from the sender or the receiver.

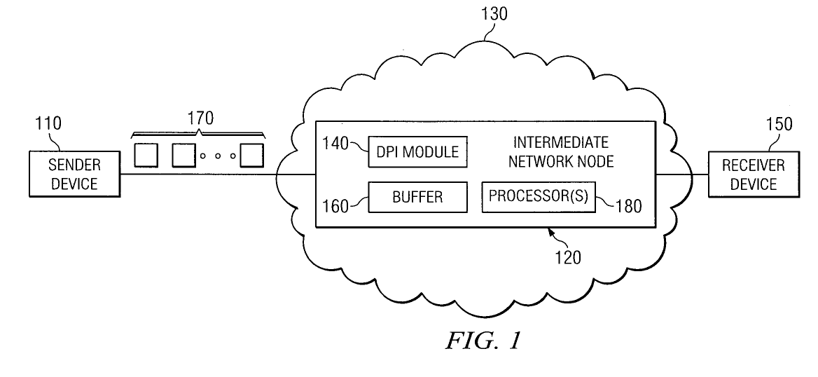

FIG. 1 illustrates an embodiment of a system for prioritizing network datagram traffic using deep packet inspection. The system 100 includes a sender device 110 in communication with an intermediate network node 120 within a network 130. In at least one embodiment, the intermediate network node 120 is a network controller. In an example embodiment of the invention, the network 130 is a packet-based network. The intermediate network node 120 is further coupled to a receiver device 150. In an example embodiment, the sender device 110 includes a server (not shown) and the receiver device 150 includes a user terminal (not shown) used to retrieve data from the server. For example, the sender device 110 may include a media server that sends audio and/or video data in datagram packets 170 to the receiver device 150 upon request. In various embodiments, the intermediate network node 120 is configured to control the flow of network traffic between the sender device 110 and the receiver device 150. In at least one embodiment, intermediate network node 120 includes a network buffer 160. The network buffer 160 is configured to temporarily store one or more datagram packets 170 for use during prioritizing and controlling transmission of the packets, as well as providing for desired network performance. The network buffer 160 allows for storing of low priority traffic before forwarding the traffic to its destination on a best effort basis. In a particular embodiment, the intermediate network node 120 includes processor(s) 180 for executing instructions configured to perform the various operations of the intermediate network node 150 described herein.

The intermediate network node 120 further includes a deep packet inspection module 140. In a particular embodiment, the DPI module 140 includes at least one processor for executing instructions operable to perform the various operations of the DPI module 140 described herein. The DPI module 140 identifies one or more datagram packets 170, such as user datagram protocol (UDP) packets, as they traverse through the network 130 using deep packet inspection techniques to produce deep packet inspection information. The DPI information includes traffic priority information associated with the datagram packet(s) 170. In at least one embodiment, the DPI information includes information that may be used by various network nodes, such as the sender device 110, intermediate network node 120, and/or receiver device 150, to prioritize traffic associated with the datagram packet(s) 170. In an example operation, datagram packets 170 transmitted from the sender device 110 to the receiver device 150 that are given a low priority as a result of deep packet inspection by the DPI module 140 are stored in the network buffer 160 of the intermediate network node 120 until packets of a higher priority being communicated from another device (not shown) are routed to their destination. In a particular embodiment, the intermediate network node 120 includes a processor(s) 180 for executing instructions configured to perform various operations of the intermediate network node 120 described herein.

With deep packet inspection, signatures are used to identify specific network applications and protocols in use over a network. In a broad sense, signatures are patterns of data bit “recipes” which are chosen to uniquely identify an associated application or protocol. When a new application or protocol is encountered, the datagram packets of the new application are analyzed and an appropriate signature is developed and added to a database, typically referred to as a signature library. In an embodiment of the invention, datagram packets transmitted by a particular application or protocol are received, and the packets are analyzed using deep packet inspection to generate a signature. The signature may then be compared to entries in the signature library, and if a match is found, the data packets are identified as being associated with a particular application or protocol identified in the signature library.

Application signatures should be updated on a regular basis as they tend to vary as new application updates or protocol revisions occur. For example, peer-to-peer file sharing applications tend to upgrade their client software on a regular basis and encourage, and, in some cases, even force users to move on to the new release. The use of these new releases with non-up-to-date signatures affect classification performance.

Although a signature is developed with the intention to uniquely and completely identify its related application or protocol, there are cases in which the signature is not robust (a.k.a. weak signature) and classification problems arise. False positives is the basic terminology referring to misclassification, or in simple terms, the likelihood that an application will be identified as something it is not. If DPI is being used for guiding a subscriber management tool, this may lead to wrongful actions. A typical example of such a wrongful action could be the mistaken lowering of priorities to time-sensitive streaming traffic and the resultant introduction of unwanted latency or even packet loss. Consequently, when developing signatures, every effort should be made to achieve a low percentage of false positives. A common way to strengthen a weak signature is to use a combination of more than one pattern. False negatives refers to those cases where it is not possible to consistently identify an application—sometimes the identification is classified, while other times it is missed by the classification tool. The most common reason for this phenomenon is that some applications can accomplish similar outcomes in several ways in different deployment scenarios. For example, some applications behave differently if the client software operates through a proxy or firewall compared to a simpler case in which the client interacts with the web directly.

Several analysis techniques are used in deep packet inspection to identify and classify traffic to generate a signature. These techniques may range from analysis by port, by string match, by numerical properties, by behavior, and by heuristics. Analysis by port is probably the easiest and most well known form of signature analysis because many applications use either default ports or some chosen ports in a specific manner. An example is Post Office Protocol version 3 (POP3) used for email applications. An incoming POP3 connection typically uses port 110, and if it is a secure connection, it will use port 995. The outgoing SMTP is port 25. However, since it is very easy to detect application activity by port, this is in fact a weakness, particularly because many current applications disguise themselves as other applications. The most notorious example is the Port 80 syndrome, where many applications camouflage as pure HTTP traffic. Some applications select random ports instead of using fixed default ports. In this case, there is often some pattern involved in the port selection process, for example, the first port may be random, but the next will be the subsequent one, and so forth. However, in some cases the port selection process may be completely random. For all these reasons, it is often not feasible to use analysis by port as the only tool for identifying applications, but rather as a form of analysis to be used together with other tools.

Analysis by string match involves searching for a sequence (or string) of textual characters or numeric values within the contents of a packet. Furthermore, string matches may include several strings distributed within a packet or several packets. For example, many applications still declare their names within the protocol itself, as in Kazaa, where the string “Kazaa” can be found in the User-Agent field with a typical HTTP GET request. From this example, it is possible to understand the importance of DPI for correct classification. If analysis is performed by port analysis alone, then port 80 may indicate HTTP traffic and the GET request will further corroborate this observation. If the User-Agent field information is missing, this analysis results in an inaccurate classification (e.g., HTTP and not Kazaa).

Analysis by numerical properties involves the investigation of arithmetic characteristics within a packet or several packets. Examples of properties analyzed include payload length, the number of packets sent in response to a specific transaction, and the numerical offset of some fixed string (or byte) value within a packet. For example, consider the process for establishing a TCP connection using some user datagram protocol (UDP) transactions in Skype (versions prior to 2.0). The client sends an 18 byte message, expecting in return an 11 byte response. This is followed by the sending of a 23 byte message, expecting a response which is 18, 51 or 53 bytes. Using numerical analysis combined with other techniques of deep packet inspection, such a pattern can be detected and the particular application can be identified.

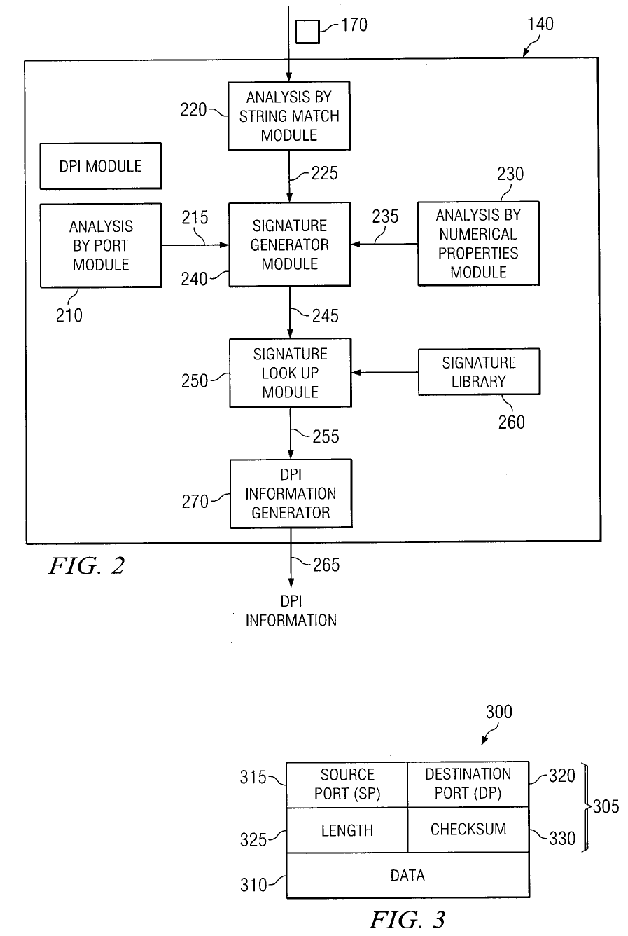

FIG. 2 illustrates an embodiment of a DPI module 140. The DPI module 140 includes an analysis by port module 210, an analysis by string match module 220, and an analysis by numerical properties module 140. A datagram packet 170 received by the DPI module 140 is provided to each of the modules 210, 220, 230. The analysis by port module 210 performs analysis by port DPI techniques, such as those described herein, upon the datagram packet 170 (i.e., on the contents of the datagram packet 170) to generate a result 215. The analysis by string match module 220 performs an analysis by string DPI techniques, such as those described herein, on the datagram packet 170 to generate a result 225. The analysis by numerical properties module 230 performs analysis by numerical properties DPI techniques, such as those described herein, to generate a result 235. Results 215, 225, and 235 are provided to a signature generator module 240. The signature generator module 240 generates a DPI signature 245 associated with the datagram packet 170 based upon results 215, 225, and 235. The DPI signature 245 is provided to a signature lookup module 250. The signature lookup module 250 performs a lookup of the DPI signature 245 from a signature library 260 to determine an identity 255 of one or more of a particular application and protocol associated with the datagram packet 170. The identity 255 of the DPI signature is provided to a DPI information generator 270 that functions to determine DPI information 265 based upon the identity 255 of the DPI signature.

Continuing with FIG. 1, the intermediate network node 120 controls and prioritizes the datagram packet traffic flowing between the sender device 110 and the receiver device 150 according to the DPI information. In at least one embodiment, the intermediate network node 120 controls the sending of a datagram packet to the receiver device 150 based upon the traffic priority information. In some embodiments, the intermediate network node 120 sends the DPI information to one or more of the sender device 110 and the receiver device 150. In some embodiments, the intermediate network node 120 sends the DPI information to one or more of the sender device 110 and the receiver device 150 in the transport layer. In at least one embodiment, the DPI information is sent to the sender device 110 and/or the receiver device 150 in a TCP packet. In another embodiment, the DPI information is sent to the sender device 110 and/or the receiver device 150 in a UDP packet. In such embodiments, the sender device 110 and/or the receiver device 150 may also control and/or prioritize traffic between sender device 110 and the receiver device 150 according to the DPI information.

FIG. 3 illustrates an embodiment of a user datagram protocol (UDP) packet 300. UDP is a transport layer protocol in which no attempt is made to keep track of datagram packets as to their being in sequence or to verify that they are received. Checks are made to determine if the datagram packet appears to be the same packet that was transmitted by evaluation of a checksum and comparison to a checksum contained in the datagram packet. A datagram packet is dropped if the destination calculations of the checksum differ from the checksum in the datagram packet, but no attempt is made to retransmit the datagram packet if the checksum differs. The UDP packet 300 includes a header portion 305 and a data portion 310. The header portion 305 includes a source port (SP) field 315, a destination port (DP) field 320, a length field 325 and a checksum field 330. The SP field 315 is a 16 bit field that identifies the port on which the sender device is waiting to listen for responses from the receiver device 150. The DP field 320 is a 16 bit field that identifies the port on the receiver device 150 that is to be used to receive the UDP packet 300. The length field 325 is a 16 bit field that identifies the length in bytes of the entire UDP packet 300 including the bytes in the header portion 305. The length of the UDP packet 300 indicated in the length field 325 is 8 bytes plus the number of bytes in the data portion 310. The checksum field 330 is a 16-bit checksum field used for error-checking of the header portion 305 and the data portion 310. The checksum field 330 allows the receiver device 150 to verify the integrity of the UDP packet 300. At the sender device 110, the checksum field 330 is loaded with a predefined value, a checksum is computed on the header portion 305 and the data portion 310, and the checksum is written into the checksum field 330 over the previous value. When the UDP packet 300 arrives at the receiver device 150, the receiver device 150 calculates a checksum on the UDP packet 300 without anything in the checksum field 330. The receiver device 150 compares the calculated checksum with the one that was transmitted in the checksum field 330 of the UDP packet 300. If the checksums are the same, the UDP packet 300 is accepted. If there is a difference in the checksums, the UDP packet 300 is dropped by the receiver device 150 and no attempt is made by the receiver device 150 to obtain a new copy. That is, the sender device 110 will not try to resend the same UDP packet 300.

The data portion 310 of the UDP packet 300 includes the data payload of the UDP packet 300. The payload of the data portion 310 may be formatted according to a number of protocols. Some protocols commonly used in a UDP packet 300 include network file system (NFS), domain name service (DNS), as well as a number of audio and video streaming protocols. If an error occurs in a UDP packet 300 and the error is desired to be fixed, it is left to application layer applications to find the error and request retransmission of the data. In various embodiments, the payload of the data portion 310 includes real-time data. In at least one embodiment, real-time data includes data that is transmitted immediately after it is generated. An example of real-time data according to one embodiment is voice data that is generated during a Voice-over-IP (VoIP) call.

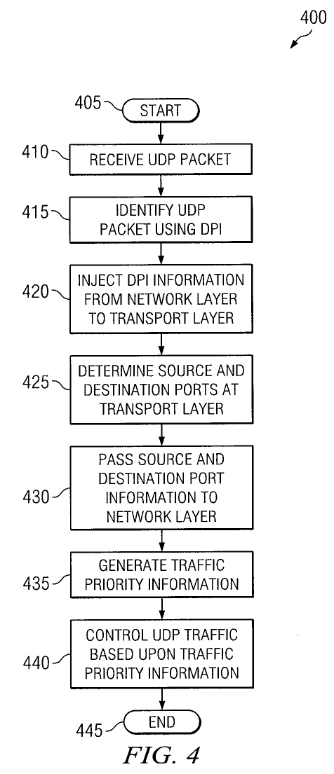

FIG. 4 illustrates an embodiment of a procedure 400 for prioritizing network datagram traffic using deep packet inspection (DPI). With reference to FIGS. 1, 3, and 4, the procedure 400 starts in step 405. In step 410, a UDP packet 300 may be sent from sender device 110, and addressed to the receiver device 150, and be received at the intermediate network node 120. In step 415, the UDP packet 300 is identified in the network layer (layer 3 of the OSI model) by the DPI module 140 of the intermediate network node 120 using DPI, which may include using one or more of the techniques for deep packet inspection described herein. In the embodiment illustrated in FIG. 4, the DPI module 140 performs DPI only on the network layer of the UDP packet 300. Identification of the UDP packet 300 by DPI allows the DPI module 140 to determine the identity of one or more of a particular application and protocol that the sender device 110 and the receiver device 150 are using to communicate with one another, and generate DPI information based on the identification.

In step 420, the DPI information is injected from the network layer into the transport layer (layer 4 of the OSI model) of the UDP packet 300. In step 425, the source port and destination port are determined from the SP field 315 and DP field 320, respectively, of the header portion 305 of the UDP packet 300 at the transport layer. In step 430, the source port and destination port information is passed back to the network layer. In step 435, the DPI module 140 generates traffic priority information associated with the UDP packet 300 based on the DPI information and the source and destination port information. The traffic priority information indicates how the flow of the UDP traffic from the sender device 110 to the receiver device 150 is to be prioritized. Examples of traffic priority information includes stopping of sending UDP packets, slowing down of the sending of UDP packets, rerouting of UDP traffic, starting of billing for the UDP traffic, stopping of billing for the UDP traffic, continuing of sending of the UDP traffic, pausing of the UDP traffic, and indicating a priority of the UDP traffic relative to other traffic in the network 130. In step 440, the sending of UDP traffic, such as UDP packet 300, between the sender device 110 and the receiver device 150 is controlled using the network buffer 160 based upon the traffic priority information. In at least one embodiment, the UDP packet 300 is forwarded by the intermediate network node 120 based upon the traffic priority information. In step 445, the procedure 400 ends.

In an example operation, UDP packets 300 transmitted from the sender device 110 to the receiver device 150 that are given a low priority as a result of deep packet inspection by the DPI module 140 are stored in the network buffer 160 of the intermediate network node until packets of a higher priority being communicated from another device (not shown) can be routed to their destination. The intermediate network node 120 may then forward to the UDP packets 300 the receiver device 150 based on the traffic priority information. The network buffer 160 allows for the storing of low priority traffic before forwarding the traffic to its destination on a best effort basis. In at least one embodiment, the network buffer 160 includes memory of a size that is large enough to temporarily store a predetermined number of UDP packets 300 to maintain a desired level of network performance. In a particular embodiment, the network buffer 160 is 1 gigabyte (GB) in size.

In some embodiments, the intermediate network node 120 also sends the traffic priority information to one or more of the sender device 110 and the receiver device 150 in the transport layer. In such embodiments, the sender device 110 and/or the receiver device 150 may also control and/or prioritize traffic between sender device 110 and the receiver device 150 according to the traffic priority information.

In still other embodiments, the intermediate network node 120 may include the DPI module 140 and a separate network controller within the network 130 may include the buffer 160. In such embodiments, the intermediate network node 120 may perform steps 410-435 as described above to determine the traffic priority information, and send the traffic priority information to the network controller in a UDP or TCP packet. The centralized network controller may then perform step 440 of controlling the sending of UDP traffic between the sender device 110 and the receiver device 150 using the network buffer 160 based upon the traffic priority information.

The illustrative embodiments can take the form of an entirely hardware embodiment, an entirely software embodiment or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device. In various embodiments, the intermediate network node 120 includes one or more processors operable to execute computer executable instructions from a computer-usable or computer-readable medium to perform the various capabilities of the intermediate network node 120 described herein.

The medium can be an electronic, magnetic, optical, electromagnetic, infrared or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Further, a computer storage medium may contain or store a computer-readable program code such that when the computer-readable program code is executed on a computer, the execution of this computer-readable program code causes the computer to transmit another computer-readable program code over a communication link. This communication link may use a medium that is, for example without limitation, physical or wireless.

The previous detailed description is of a small number of embodiments for implementing the invention and is not intended to be limiting in scope. One of skill in this art will immediately envisage the methods and variations used to implement this invention in other areas than those described in detail. For example, although the described embodiments are directed to deep packet inspection being performed at an intermediate network node, it should be understood that these procedures may be performed at any node within the network. Although some particular embodiments are described with respect to using DPI in a network layer, it should be understood that the principles described herein may be used with any layer regardless of the particular network configuration or technologies used. The following claims set forth a number of the embodiments of the invention disclosed with greater particularity.

What is claimed as new and desired to be protected by Letters Patent of the United States is:

1. A method for prioritizing network datagram traffic comprising:
receiving a datagram packet from a sender device, the datagram packet addressed to a receiver device and including a real-time data payload;
identifying the datagram packet in a network layer using deep packet inspection to determine at least one of an application or protocol associated with the datagram packet; and
generating traffic priority information associated with the datagram packet based upon identifying the datagram packet, the traffic priority information indicating traffic prioritization between the sender device and the receiver device.

2. The method of claim 1, further comprising controlling of sending of the datagram packet to the receiver device based upon the traffic priority information.

3. The method of claim 1, further comprising prioritizing traffic between the sender device and the receiver device in accordance with the traffic priority information.

4. The method of claim 1, wherein generating traffic priority information further comprises determining a source port and a destination port associated with the datagram packet.

5. The method of claim 1, further comprising sending the traffic priority information to at least one of the sender device and the receiver device.

6. The method of claim 5, wherein sending the traffic priority information to at least one of the sender device and the receiver device includes sending the traffic priority information in a transport layer.

7. The method of claim 1, further comprising:
sending the traffic priority information to a network controller; and
controlling sending of the datagram packet from the sender device to the receiver device based upon the traffic priority information.

8. The method of claim 1, wherein identifying the packet in the network layer includes performing analysis by port on the datagram packet.

9. The method of claim 1, wherein identifying the packet in the network layer includes performing analysis by string match on the datagram packet.

10. The method of claim 1, wherein identifying the packet in the network layer includes performing analysis by numerical properties on the datagram packet.

11. An apparatus for prioritizing network datagram traffic comprising:
at least one processor, the at least one processor configured to:
receive a datagram packet from a sender device, the datagram packet addressed to a receiver device and including a real-time data payload;
identify the datagram packet in a network layer using deep packet inspection to determine at least one of an application or protocol associated with the datagram packet; and
generate traffic priority information associated with the datagram packet based upon identifying the datagram packet, the traffic priority information indicating traffic prioritization between the sender device and the receiver device.

12. The apparatus of claim 11, wherein the at least one processor is further operable to control sending of the datagram packet to the receiver device based upon the traffic priority information.

13. The apparatus of claim 11, wherein the at least one processor is further operable to prioritize traffic between the sender device and the receiver device in accordance with the traffic priority information.

14. The apparatus of claim 11, wherein the at least one processor is further operable to determine a source port and a destination port associated with the datagram packet to generate the traffic priority information.

15. The apparatus of claim 11, wherein the at least one processor is further operable to send the traffic priority information to at least one of the sender device and the receiver device.

16. The apparatus of claim 11, wherein the at least one processor is further operable to send the traffic priority information to at least one of the sender device and the receiver in a transport layer.

17. The apparatus of claim 11, wherein the at least one processor is further operable to send the traffic priority information to a network controller, the network controller operable to control sending of the datagram packet from the sender device to the receiver device based upon the traffic priority information.

18. The apparatus of claim 11, wherein the at least one processor is further operable to perform analysis by port on the datagram packet when identifying the packet in the network layer.

19. The apparatus of claim 11, wherein the at least one processor is further operable to perform analysis by string match on the datagram packet when identifying the packet in the network layer.

20. The apparatus of claim 11, wherein the at least one processor is further operable to perform analysis by numerical properties on the datagram packet when identifying the packet in the network layer.
